(19) United States
(12) Patent Application Publication
(10) Pub. No.: US 2008/0202449 A1
(43) Pub. Date: Aug. 28, 2008

(54) Engine System

(75) Inventors: Atsushi SHIMADA, Hitachinaka (JP); Takao Ishikawa, Hitachi (JP); Akiyoshi Komura, Hitachi (JP); Masatoshi Sugimasa, Tokai (JP); Takeyuki Itabashi, Aki (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 11/971,296

(22) Filed: Jan. 9, 2008

(30) Foreign Application Priority Data
Feb. 28, 2007 (JP) 2007-049932

(51) Int. Cl. F02B 43/08

(52) U.S. Cl. 123/3; 701/103

(57) ABSTRACT

An engine system comprises a detection means for detecting a supply quantity or supply pressure of hydrogen rich gas which is disposed in a hydrogen rich gas supply pipe for supplying hydrogen rich gas to a combustion chamber of the engine, a hydrogen rich gas supply valve control means for controlling the supply of hydrogen rich gas by controlling the open/close timing and the amount of open/close lift of the hydrogen rich gas supply valve disposed in the combustion chamber of the engine based on the supply quantity or supply pressure detected by the detection means, an inlet valve for supplying air to the combustion chamber of the engine separately from the hydrogen rich gas supply valve, and an inlet valve control means for controlling the volume of air taken into the combustion chamber of the engine by the inlet valve.

### CLAIM OF PRIORITY

The present application claims priority from Japanese application serial No. 2007-049932, filed on Feb. 28, 2007, the content of which is hereby incorporated by reference into this application.

### BACKGROUND OF THE INVENTION

1. Field of the Invention

The present invention relates to an engine system for driving an engine by using hydrogen gas as one of fuels.

2. Description of Related Art

Under the circumstances in which movement away from fossil fuel is required due to the global warming issues, an engine system which drives an engine by using hydrogen gas as a fuel has been developed. There are two methods by which air and hydrogen gas are supplied to an engine cylinder (combustion chamber): one is a method for supplying air and hydrogen gas to a cylinder through one supply pipe, and the other is a method for supplying air and hydrogen gas through different supply pipes individually. When comparing the above two methods, a method for supplying air and hydrogen gas through different pipes is considered to be more preferable because a larger quantity of mixture of air and hydrogen gas can be supplied to a cylinder. Herein, there are two methods by which hydrogen gas is supplied to a cylinder: one is a method for injecting hydrogen gas by using an injector, and the other is a method for supplying hydrogen gas to a cylinder by opening and closing a valve by using negative pressure in the cylinder. In the method that uses an injector, high injection pressure is required to supply a prescribed amount of hydrogen gas or more due to a small diameter of an injection port through which hydrogen gas is injected; therefore, a pressure rising means such as a pressure pump is necessary. On the contrary, a valve control system that uses negative pressure in the cylinder is advantageous because the system does not require high pressure necessary for an injector. A well-known system for supplying hydrogen to an engine by means of such valve control is a method that uses one valve disposed in the engine to supply fuel and controls the supply of hydrogen by changing the valve's open-period (for example, Patent Document 1).

Patent Document 1: Japanese Patent Laid-open No. Sho 63 (1988)-195369

### SUMMARY OF THE INVENTION

As a first means, an engine system for driving an engine by using hydrogen rich gas as one of the fuels comprises a detection means for detecting a supply quantity or supply pressure of hydrogen rich gas which is disposed in a hydrogen rich gas supply pipe for supplying hydrogen rich gas to a combustion chamber of the engine, a hydrogen rich gas supply valve control means for controlling the open/close timing and the amount of open/close lift of the hydrogen rich gas supply valve disposed in the combustion chamber of the engine based on the supply quantity or supply pressure detected by the detection means, an inlet valve for supplying air to the combustion chamber of the engine separately from the hydrogen rich gas supply valve, and an inlet valve control means for controlling the volume of air taken into the combustion chamber of the engine by the inlet valve.

### BRIEF DESCRIPTION OF THE DRAWINGS

FIG. 1 is a schematic diagram of an engine system.

FIG. 2 shows a configuration of a hydrogen supply apparatus.

FIG. 3 shows changes of amounts of open/close lift of a hydrogen rich gas supply valve and an inlet valve.

FIG. 4 shows changes of amounts of open/close lift of a hydrogen rich gas supply valve and an inlet valve in the case of a low load.

FIG. 5 shows changes of amounts of open/close lift of a hydrogen rich gas supply valve and an inlet valve in the case of a high load.

FIG. 6 shows a relationship between an excess air factor and an amount of NOx emission at the time of the combustion of hydrogen rich gas.

FIG. 7 shows the relationship between an excess air factor and an engine efficiency at the time of the combustion of hydrogen rich gas.

FIG. 8 shows a relationship between a catalyst temperature of a hydrogen supply apparatus and an conversion rate to convert a hydrogenation medium into hydrogen.

FIG. 9 is a schematic diagram of an engine system equipped with a diversion valve 20.

FIG. 10 is a map of fuels supplied to an engine.

FIG. 11 shows a control flow in selecting a fuel which is supplied to an engine system.

FIG. 12 is a schematic diagram of an engine system which supplies hydrogen rich gas to an inlet pipe.

### DETAILED DESCRIPTION OF THE INVENTION

In Patent Document 1, while the supply pressure of hydrogen gas supplied from hydrogen storing alloy is kept constant, the supply quantity of hydrogen is controlled by changing the open-period of a valve to supply a prescribed amount of hydrogen, and then air is taken into a cylinder with the application of pressure by a supercharger. However, in the case in which hydrogen rich gas is generated from hydrogen storing alloy or a medium (organic hydride), which chemically repeats storage and release of hydrogen by using a catalyst reaction, and supplied, supply pressure of hydrogen rich gas fluctuates depending on the operating conditions. Accordingly, it is difficult to maintain a constant value of the hydrogen supply pressure. Specifically, when hydrogen is supplied by using organic hydride, supply pressure of generated hydrogen rich gas fluctuates depending on the conditions, such as a catalyst temperature, quantity of organic hydride supplied to a catalyst, and an amount of generated hydrogen. Therefore, it is difficult to maintain a constant value of the hydrogen supply pressure.

Considering exhaust performance and gas mileage efficiency, it is necessary to control a volume of air according to the amount of hydrogen supplied to an engine. However, the system described in Patent Document 1 does not consider the case in which supply pressure of hydrogen rich gas supplied from a hydrogen supply apparatus fluctuates. Therefore, it is difficult to accurately control the mixture ratio of air and hydrogen rich gas and the supply quantity.

It is an object of the present invention to provide an engine system for driving an engine by using hydrogen gas as one of the fuels, which can accurately control the quantity of air and hydrogen rich gas supplied to a combustion chamber and has excellent exhaust performance and gas mileage efficiency.

As a first means, an engine system for driving an engine by using hydrogen rich gas as one of the fuels comprises a detection means for detecting a supply quantity or supply pressure of hydrogen rich gas which is disposed in a hydrogen rich gas supply pipe for supplying hydrogen rich gas to a combustion chamber of the engine, a hydrogen rich gas supply valve control means for controlling the open/close timing and the amount of open/close lift of the hydrogen rich gas supply valve disposed in the combustion chamber of the engine based on the supply quantity or supply pressure detected by the detection means, an inlet valve for supplying air to the combustion chamber of the engine separately from the hydrogen rich gas supply valve, and an inlet valve control means for controlling the volume of air taken into the combustion chamber of the engine by the inlet valve.

As a second means, an engine system for driving an engine by using hydrogen rich gas as one of the fuels comprises an inlet valve disposed in the combustion chamber of the engine, an inlet pipe connected to the inlet valve, and a hydrogen rich gas supply pipe which is connected to the inlet pipe to supply the hydrogen rich gas to the engine, wherein a diversion valve is disposed at the connection between the inlet pipe and the hydrogen rich gas supply pipe.

According to the present invention, it is possible to provide an engine system for driving an engine by using hydrogen rich gas as one of the fuels, which can accurately control the quantity of air and hydrogen rich gas supplied to the combustion, thereby achieving excellent exhaust performance and gas mileage efficiency.

Hereafter, an embodiment of the present invention will be described with reference to the drawings.

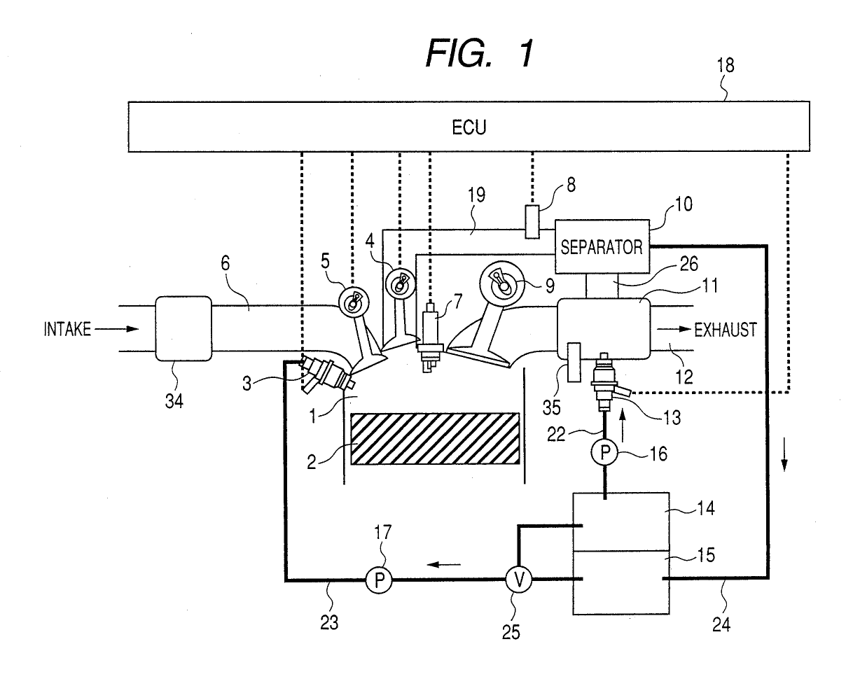

FIG. 1 shows a system in which a hydrogen supply apparatus 11 for executing a dehydrogenation reaction of a medium, which chemically repeats storage and release of hydrogen, is disposed in an engine's exhaust pipe 12 so as to utilize the heat of exhaust gas discharged by the engine 1. A hydrogenation medium is supplied to the hydrogen supply apparatus 11 by a hydrogenation medium supply apparatus 13. Furthermore, a catalyst temperature detection device 35 is disposed in the hydrogen supply apparatus 11.

The above-mentioned medium means any substance that can chemically store and release hydrogen, such as hydrocarbon fuels including gasoline, light oil, kerosene, heavy oil, decalin, cyclohexane, methylcyclohexane, naphthalene, benzene, and toluene and mixture of those fuels, hydrogen peroxide, ammonia, nitrogen, and oxygen. Specifically, hereafter, a medium which chemically stores hydrogen is to be called a “hydrogenation medium,” and a medium which has chemically released hydrogen is to be called a “dehydrogenation medium.” The hydrogenation medium and dehydrogenation medium are separately stored in each storage device 14, 15. Those storage devices can be integrated into one unit. The system is constructed such that a hydrogenation medium is supplied from a hydrogenation medium supply apparatus (injector) 13 to a hydrogen supply apparatus 11 through a pipe 22 by the pressure of a pump 16. Furthermore, the configuration allows a diversion valve 25 to select a hydrogenation medium and a dehydrogenation medium to be supplied to an engine 1 and supply the media from a medium supply apparatus (injector) 3 to the engine 1 through a medium supply pipe 23 by the pressure of a pump 17.

A mixture of hydrogen rich gas and a dehydrogenation medium generated by the hydrogen supply apparatus 11 is carried to a separator 10 through a pipe 26 and is separated into hydrogen rich gas and dehydrogenation fuel by the separator 10. After that, the dehydrogenation medium is stored in a dehydrogenation medium storage device 15 through a pipe 24. On the other hand, hydrogen rich gas is supplied to the combustion chamber of the engine 1 through a hydrogen rich gas supply pipe 19. At that time, a hydrogen rich gas supply valve 4 regulates the quantity of hydrogen rich gas supplied to the engine 1. The open/close timing and the amount of open/close lift of the hydrogen rich gas supply valve 4 can be variably controlled. Furthermore, the hydrogen rich gas supply pipe 19 is equipped with a detection device 8 for detecting a supply quantity of hydrogen rich gas or supply pressure. Moreover, a hydrogen concentration detection device can be disposed in the hydrogen rich gas supply pipe 19.

Air is supplied to an engine 1 via an inlet valve 5 through an inlet pipe 6 separately from the above-mentioned hydrogen rich gas supply valve 4. The open/close timing and the amount of open/close lift of the inlet valve 5 can be variably controlled, thereby controlling the volume of air supplied to an engine 1. The inlet pipe 6 is equipped with a compressor 34 that can supercharge air.

In this system, a hydrogen rich gas supply valve 4, inlet valve 5, detection device 8, medium supply apparatuses (injector) 3, 13, and a spark plug 7 are electrically connected to a control apparatus (ECU) 18 and controlled by a control apparatus 18.

This embodiment is configured such that hydrogen rich gas generated by a hydrogen supply apparatus 11 is supplied to an engine 1 from a hydrogen rich gas supply pipe without passing through a pressure device. By using negative pressure at the intake stroke of an engine 1, it is possible to supply hydrogen rich gas by opening and closing a hydrogen rich gas supply valve. For this reason, a pressure device for supplying hydrogen rich gas is not necessary. Furthermore, a hydrogen rich gas supply valve 4 is directly disposed in an engine 1; therefore, the flow rate for supplying hydrogen rich gas can be larger than that of a case in which an injector is used. Furthermore, this embodiment is structured such that the open/close timing and the amount of open/close lift of the hydrogen rich gas supply valve 4 can be variably controlled. The quantity of hydrogen rich gas to be supplied to an engine 1 is determined by an output required by the engine 1. With regard to the hydrogen rich gas supply quantity, based on the supply quantity of hydrogen rich gas detected by a detection device 8 or supply pressure, the open/close timing and the amount of open/close lift of the hydrogen rich gas supply valve 4 are controlled. Thus, even if supply pressure and supply quantity of hydrogen rich gas generated by a hydrogen supply apparatus 11 fluctuate, supply quantity or pressure of hydrogen rich gas is detected and fed back to the control of the hydrogen rich gas supply valve 4; therefore, it is possible to accurately supply a necessary quantity of hydrogen rich gas to an engine. Furthermore, the volume of air supplied to a combustion chamber is controlled by controlling the open/close timing and the amount of open/close lift of an inlet valve according to the quantity of hydrogen rich gas supplied to a combustion chamber; therefore, it is possible to accurately control the supply quantity of hydrogen rich gas and air and a air-fuel ratio with regard to the output required by an engine 1. Consequently, excellent exhaust performance and fuel efficiency can be obtained.

Furthermore, this system has a characteristic in that backfire which becomes problematic with an ordinary hydrogen engine does not easily occur. This results from a characteristic in that air is supplied to an engine 1 after hydrogen rich gas has been supplied to the engine 1, therefore, a combustible gas mixture of hydrogen and air is not easily distributed around the spark plug 7 at the intake stroke of the engine.

In this system, even if supply quantity of hydrogen rich gas generated by a hydrogen supply apparatus 11 and supply pressure fluctuate according to the operating conditions, the supply quantity of hydrogen rich gas and air can be regulated at a prescribed air-fuel ratio. However, it is preferable that supply pressure of hydrogen rich gas remain constant as much as possible. In order to inhibit the fluctuation of the supply pressure of hydrogen rich gas, by increasing the volume of the hydrogen rich gas supply pipe more than the volume of the combustion chamber of an engine 1, it is possible to suppress the influence of pressure fluctuation in the hydrogen supply apparatus 11. Furthermore, at this point, it is effective to provide a buffer tank. Moreover, the pressure of the hydrogen supply apparatus 11 depends on the quantity of a medium supplied to a hydrogen supply apparatus 11 and a catalyst temperature. Accordingly, pressure of the hydrogen supply apparatus 11 can be regulated by controlling the quantity of a medium supplied to the hydrogen supply apparatus 11 or controlling the quantity of heat supplied to the hydrogen supply apparatus based on the supply quantity or pressure of hydrogen rich gas detected by the detection device 8.

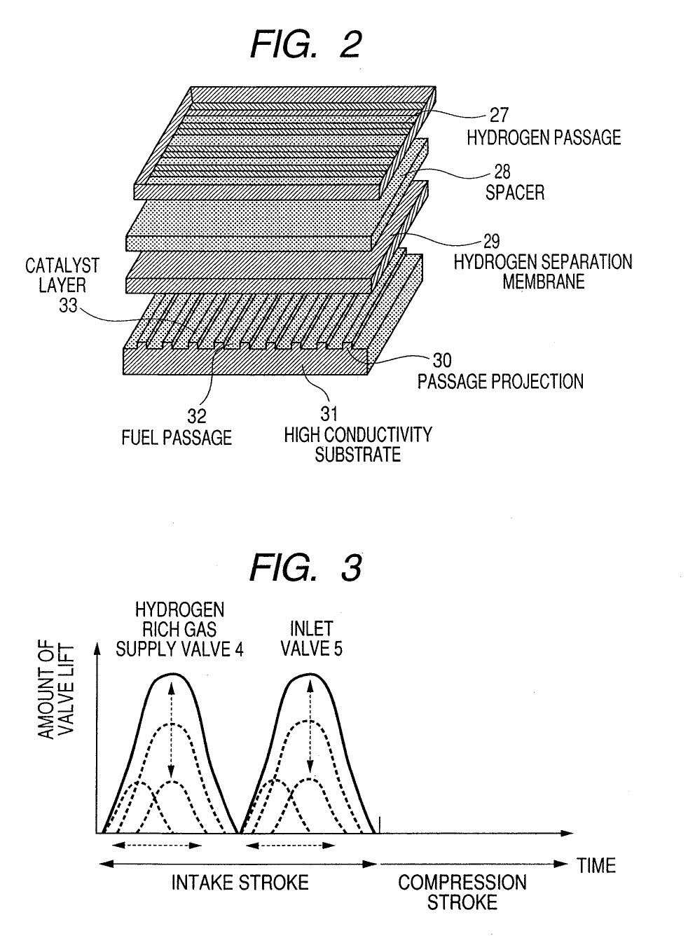

Next, configuration of the hydrogen supply apparatus 11, shown in FIG. 1, will be described with reference to FIG. 2. As shown in FIG. 2, the hydrogen supply apparatus 11 is configured such that a catalyst layer 33 made of Pt/alumina catalyst is formed on a thermally conductive pure aluminum substrate 31 (thermal conductivity: 250 W/m K) having projections 30. The basic structure is such that a hydrogen separation membrane 29 which selectively allows hydrogen to pass through is laminated on the catalyst layer 33 and then a hydrogen passage 27 is laminated thereon with a spacer 28 interposed. This basic structure is installed in an engine exhaust pipe 12.

A medium supplied to a hydrogen supply apparatus 11 passes through a fuel passage 32 while the medium comes in contact with a catalyst layer 33 formed on the surface of the thermally conductive substrate 31, thereby a dehydrogenation reaction progresses, generating hydrogen rich gas. The generated hydrogen rich gas passes through the hydrogen separation membrane 29 and is discharged from the hydrogen supply apparatus 11 via the spacer 28 through the hydrogen passage 27. Furthermore, hydrogen rich gas and a dehydrogenation medium that did not pass through the hydrogen separation membrane 29 are discharged from the hydrogen supply apparatus 11 to the outside through a fuel passage 32. The hydrogen rich gas and the dehydrogenation medium discharged therein are mixed with the hydrogen rich gas discharged from the hydrogen passage 27 and supplied to the separator 10 shown in FIG. 1. Moreover, another configuration is possible in which hydrogen rich gas discharged from the hydrogen passage 27 and hydrogen rich gas and the dehydrogenation medium discharged from the fuel passage 32 are not mixed and, through different pipes, hydrogen rich gas is supplied to a hydrogen rich gas supply pipe 19 and the hydrogen rich gas and dehydrogenation medium are supplied to a separator 10. Furthermore, in the configuration shown in FIG. 2, a hydrogen separation membrane 29 is provided in order to efficiently conduct a dehydrogenation reaction with a medium at a low temperature. However, configuration which does not include a hydrogen separation membrane 29 is also possible. Moreover, the basic structure shown in FIG. 2 can be laminated and included.

FIG. 3 shows a method of controlling the open/close timing and the amount of open/close lift of the hydrogen rich gas supply valve 4 and the inlet valve 5. The hydrogen rich gas supply valve 4 starts to open at the beginning of the intake stroke (piston 2 is located around the top dead center) and closes in the middle of the intake stroke. Simultaneously, the inlet valve 5 starts to open and it closes at the end of the intake stroke (piston 2 is located around the bottom dead center). The hydrogen rich gas supply valve 4 and the inlet valve 5 are structured such that they can continuously change the amount of open/close lift and a working angle. Accordingly, it is possible to control the hydrogen rich gas supply valve 4 and the inlet valve 5 independently. Thus, by controlling the open/close timing and the amount of open/close lift of the valves, it is possible to accurately regulate the quantity of hydrogen rich gas and air supplied to a combustion chamber when compared to the case in which only the open/close timing is controlled.

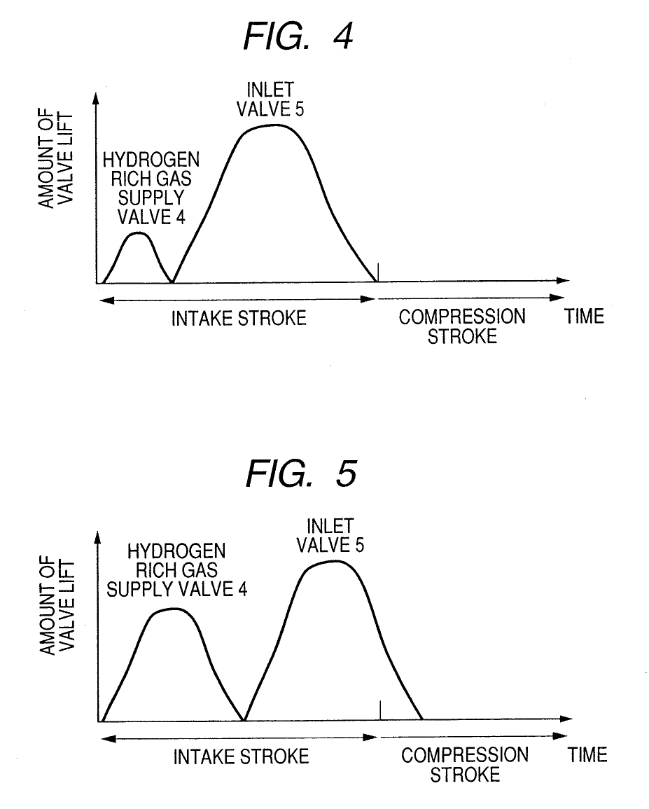

FIG. 4 shows the changes of the amount of open/close lift of the valves in the case of a low load. In the case of the low load, because the supply quantity of hydrogen is small, the working angle and the amount of open/close lift of the hydrogen rich gas supply valve 4 are small. The inlet valve 5 starts to open at the timing the hydrogen rich gas supply valve 4 closes, and the close-timing of the inlet valve 5 and the amount of open/close valve lift are controlled so that a prescribed amount of air is supplied to an engine 1. On the other hand, in the case of a high load, as shown in FIG. 5, because the supply quantity of hydrogen rich gas is large, the working angle and the amount of open/close lift of the hydrogen rich gas supply valve 4 are large. And, the inlet valve 5 starts to open at the timing the hydrogen rich gas supply valve 4 closes. At this time, when the close-timing of the inlet valve 5 goes beyond the bottom dead center of the intake stroke, air is not taken in naturally; therefore, a necessary amount of air is supplied to an engine 1 via a compressor 34.

The above-mentioned structure and control allow an engine's negative pressure to be actively used to supply hydrogen rich gas to an engine 1; consequently, it is possible to supply a necessary amount of hydrogen rich gas according to the operating conditions of the engine 1. Also, a necessary volume of air supplied to an engine 1 can be controlled accordingly; it is possible to control the ratio of the volume of intake air to hydrogen rich gas supplied to an engine 1 within a prescribed range.

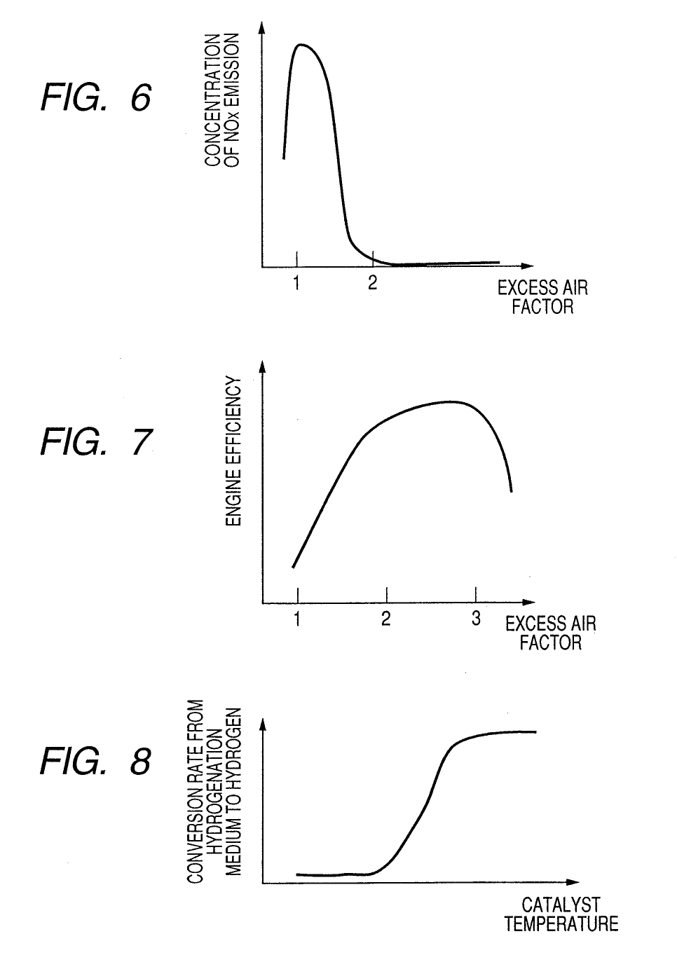

FIG. 6 shows the relationship between an excess air factor and an amount of NOx emission at the time of combustion of hydrogen rich gas. The drawing shows that the excess air factor increases around the point at which an excess air factor is 2 and the amount of NOx emission quickly decreases around that point. Furthermore, FIG. 7 shows the relationship between an excess air factor and engine efficiency. This drawing shows that the engine efficiency increases as the excess air factor increases in the prescribed range. In the light of those results, it is desirable that an engine be operated with an excess air factor of 2 to 3 from the viewpoint of exhaust gas emission and fuel efficiency. Accordingly, as mentioned above, a volume of air supplied to an engine 1 is controlled so that an excess air factor remains within a prescribed range. In the case of a high load, because the supply quantity of hydrogen rich gas is large, the open timing of the inlet valve 5 delays, and in some cases, a necessary volume of air may not be supplied to an engine 1 during the intake stroke. In such a case, a compressor 34 compresses air and supplies the air to the engine 1, resulting in controlling the ratio of the volume of intake air to the hydrogen rich gas supplied to the engine 1 within a prescribed range. The compressor 34 can be structured such that it controls the compression pressure. Furthermore, as a compressor 34, a turbocharger that uses exhaust gas energy, a supercharger that uses engine drive energy or an electrically driven turbocharger that electrically compresses air can be used. Furthermore, to ensure stable boost pressure in the wider operating zone, it is preferable that two or more chargers, such as turbochargers, superchargers, and electrically driven turbochargers, be combined and used together.

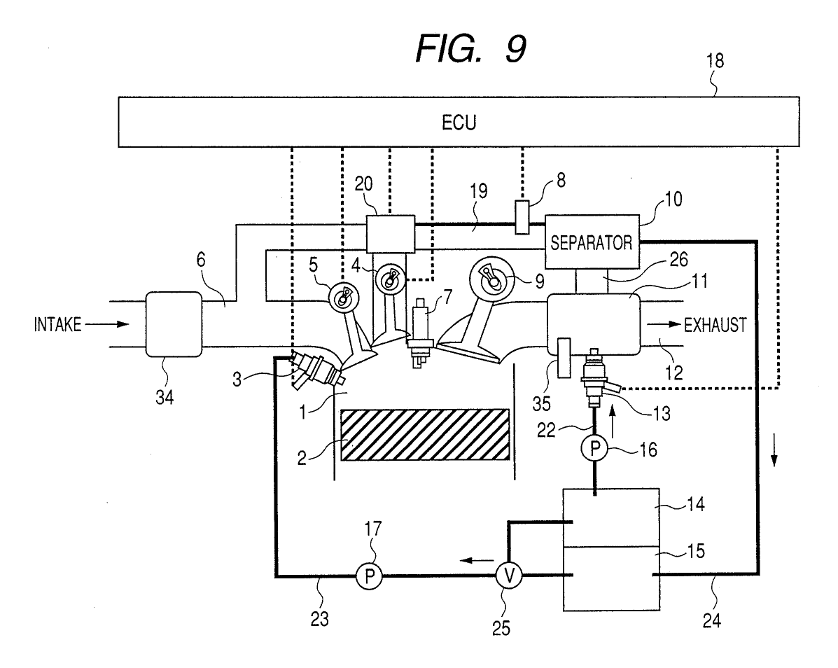

Next, reaction of hydrogen generated by a hydrogen supply apparatus 11 will be described. A hydrocarbon fuel, such as decalin, cyclohexane, methylcyclohexane, is used as a hydrogenation medium, as shown in FIG. 8, an inversion rate at the time of generation of hydrogen from the hydrogenation medium depends on the catalyst temperature. When the catalyst temperature decreases below a prescribed value, hydrogen cannot be generated. When using a hydrogenation medium showing such a characteristic, it is preferable that only a medium is supplied to an engine 1 from a medium supply apparatus 3 to drive an engine 1 when the catalyst temperature detection device 35 located in the hydrogen supply apparatus 11 shows the temperature below a prescribed range. FIG. 9 shows another embodiment of an engine system which supplies a medium as a fuel to an engine in addition to hydrogen rich gas. An engine system, shown in FIG. 9, is structured such that a diversion valve 20 is disposed in a hydrogen rich gas supply pipe 19 and the hydrogen rich gas supply pipe 19 and an inlet pipe 6 are connected by the diversion valve 20. In this engine system, it is possible to select a type of gas (hydrogen rich gas, air) supplied from a hydrogen rich gas supply/inlet valve 4′ by means of the diversion valve 20. When an engine 1 is operated by a medium only, the diversion valve 20 controls to disconnect from the hydrogen rich gas supply pipe 19 and connect to the inlet pipe 6, thereby supplying air from the hydrogen rich gas supply/inlet valve 4′. The hydrogen rich gas supply valve 4′ and the inlet valve 5 are used for taking in air and controlled so that the same operation is conducted. By switching the connections of the valves in this manner, it is not necessary to operate a compressor 34 to drive an engine 1 with a medium only. As a result, it is possible to prevent a decrease in engine efficiency associated with the operation of a compressor 34.

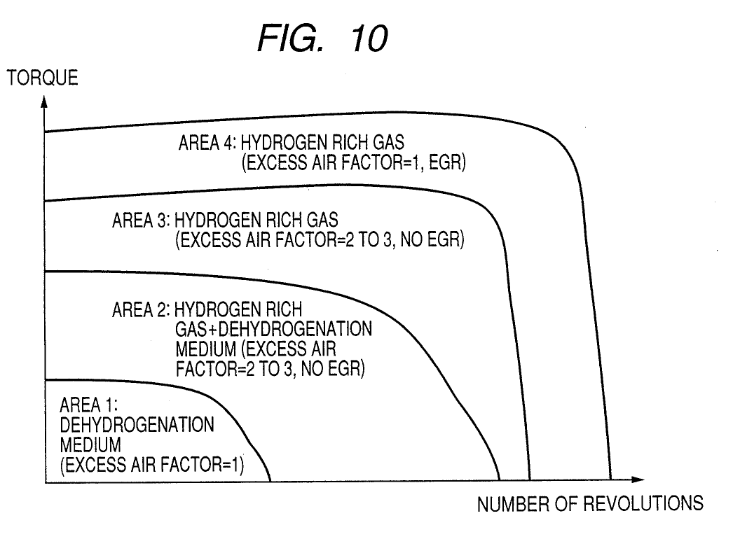

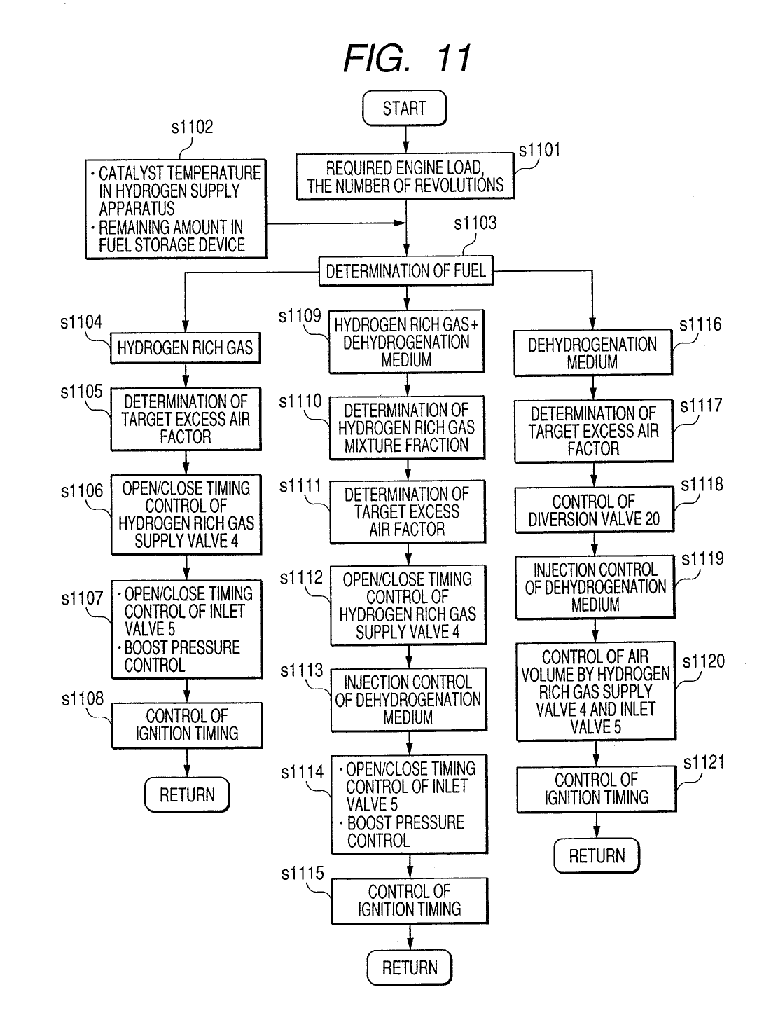

FIG. 10 shows the type of the fuel supplied to an engine 1 according to the operating condition of the engine 1, an excess air factor, and ON/OFF of the EGR (Exhaust Gas Recirculation) control when hydrocarbon fuel, such as decalin, cyclohexane, methylcyclohexane, is used as a hydrogenation medium. When a prescribed amount of dehydrogenation medium is not stored in the dehydrogenation medium storage device 15, a hydrogenation medium can be supplied in the areas 1 and 2 instead of supplying a dehydrogenation medium. FIG. 11 shows a control flow of the entire system to select a fuel to be supplied to an engine 1. In s1101, an engine load requested by a user and the number of revolutions is inputted; subsequently in s1102, the catalyst temperature is detected by a catalyst temperature detection device 35 located in the hydrogen supply apparatus 11. Alternatively, it is possible to estimate the catalyst temperature based on the exhaust gas temperatures before and after the hydrogen supply apparatus 11 and the supply quantity of hydrogenation medium. Furthermore, the remaining amount of the dehydrogenation medium storage device 15 and the hydrogenation medium storage device 14 is detected. A fuel to be supplied to an engine 1 in s1110 and s1102 is selected in s1103. In the case in which the engine's operation areas 3 and 4 are selected in FIG. 10 and the catalyst temperature is over a prescribed value, hydrogen rich gas is selected as a fuel, and a target excess air factor is determined in s1105. The excess air factor is determined according to the operation map shown in FIG. 10. The open/close timing of the hydrogen rich gas supply valve 4 is determined in s1106. At that time, the open/close timing is controlled by executing feedback control by a hydrogen rich gas supply quantity detection device 8. Next, in s1107, the open/close timing of the inlet valve 5 is determined. At that time, in the operating zone in which a volume of air that satisfies the target excess air factor cannot be supplied to an engine 1 when the close-timing of the inlet valve 5 is around the bottom dead center, air is supercharged by a compressor 34 and then supplied to the engine 1. At that time, it is possible to control the close timing of the inlet valve 5 under a constant boost pressure or control-boost pressure while the close timing of the inlet valve 5 is around the bottom dead center. Furthermore, the above-mentioned two methods can be combined to control the volume of air. In s1108, the ignition timing is controlled according to the excess air factor and the operating conditions. Next, in FIG. 10, in the case in which area 2 is selected, and the catalyst temperature in the hydrogen supply apparatus 11 is higher than a prescribed value, and a dehydrogenation medium storage device 15 stores a medium more than a prescribed value, the process goes on to s1109 from s1103 in FIG. 11. In s1110, a hydrogen rich gas mixture fraction is determined. The hydrogen rich gas mixture fraction is basically 20% or more by heat quantity ratio, and the ratio of the hydrogen rich gas supply is controlled according to the catalyst temperature in the hydrogen supply apparatus 11. In s1111, a target excess air factor is determined according to the ratio of the hydrogen rich gas supply. The excess air factor is determined to be between 2 and 3 according to the operating conditions. After that, in s1112 and s1113, the open/close timing of the hydrogen rich gas supply valve and the injection of the dehydrogenation medium are controlled. Control in s1114 and s1115 is executed in the same manner as the control executed in s1107 and s1108. Next, a dehydrogenation medium is selected in s1103 and the process goes on to s1116. In S1102, when the remaining amount of a medium in the dehydrogenation medium tank is below the prescribed range, a hydrogenation medium is selected. In s1117, a target excess air factor is determined. In this case, operation is executed with an excess air factor of 1. In s1118, a diversion valve 20 shown in FIG. 9 is switched so that it is connected to an inlet pipe 6. After that, in s1119, injection of the dehydrogenation medium is controlled, and in s1120, a hydrogen rich gas supply valve 4 and an inlet valve 5 are controlled to regulate the volume of air supplied to an engine 1. Subsequently, in s1121, the ignition timing is controlled according to the operation area.

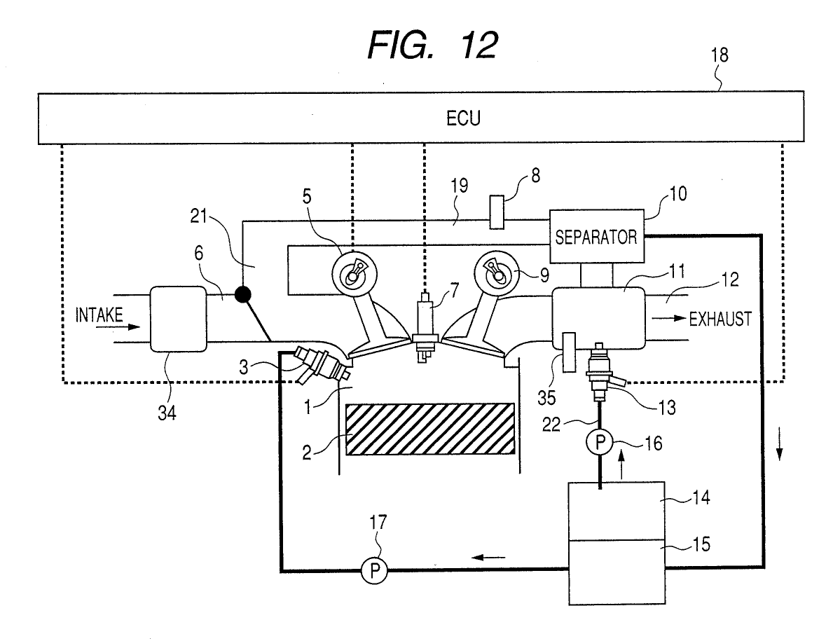

Next, FIG. 12 shows a schematic diagram of the configuration in which a hydrogen rich gas supply valve is installed in the inlet pipe instead of installing the valve in an engine's combustion chamber. In this system configuration, the inlet pipe 6 is equipped with a diversion valve 21, and either a hydrogen rich gas supply pipe 19 for supplying hydrogen rich gas or an inlet pipe 6 can be selected to be connected to an engine 1. At the beginning of the intake stroke, the engine 1 is connected to the hydrogen rich gas supply pipe 19 and a prescribed amount of hydrogen rich gas is supplied to an engine; and after that, the diversion valve 21 is switched so that the inlet pipe 6 is connected to the engine 1. Furthermore, if a prescribed volume of air is not supplied to an engine at the intake stroke, a compressor 34 is used for supercharging air, thereby control is executed so that a prescribed volume of air is supplied to an engine 1. According to this system configuration, since one valve functions as both a hydrogen rich gas supply valve and an inlet valve, it is possible to simplify components and valve control.

What is claimed is:

1. An engine system for driving an engine that uses hydrogen rich gas as one of the fuels comprising;
a detection means for detecting a supply quantity or supply pressure of the hydrogen rich gas which is disposed in a hydrogen rich gas supply pipe for supplying hydrogen rich gas to a combustion chamber of the engine,
a hydrogen rich gas supply valve control means for controlling the open/close timing and an amount of open/close lift of the hydrogen rich gas supply valve disposed in the combustion chamber of the engine based on the supply quantity or supply pressure detected by the detection means,
an inlet valve for supplying air to the combustion chamber of the engine separately from the hydrogen rich gas supply valve, and
an inlet valve control means for controlling the volume of air taken into the combustion chamber of the engine by the inlet valve.

2. The engine system according to claim 1, further comprising;
a hydrogen supply apparatus for generating hydrogen gas from a medium which chemically repeats storage and release of hydrogen, wherein
hydrogen rich gas generated by the hydrogen supply apparatus is supplied to the combustion chamber of the engine.

3. The engine system according to claim 1, wherein
the hydrogen rich gas supply valve control means and the inlet valve supply means control a ratio of a volume of intake air to the hydrogen gas supplied to the engine so that the ratio is within a prescribed range.

4. The engine system according to claim 1, wherein
air is supplied after the hydrogen gas has been supplied to the combustion chamber of the engine.

5. The engine system according to claim 1, wherein
control of the volume of the air is executed by one or more than one means selected from the group consisting of a means for controlling boost pressure, a means for controlling the open/close timing of the inlet valve and a means for controlling the amount of open/close lift of the inlet valve.

6. The engine system according to claim 2, further comprising;
a medium supply means for supplying the medium to the combustion chamber of the engine, wherein
the open/close timing and the amount of open/close lift of the hydrogen rich gas supply valve is controlled according to the supply quantity of the medium.

7. The engine system according to claim 2, further comprising;
a medium supply means for supplying the medium to the combustion chamber of the engine, wherein
the hydrogen rich gas supply valve can be switched to be used to supply air when an engine is operated only with the medium.

8. The engine system according to claim 2, further comprising;
a medium supply means for supplying the medium to the combustion chamber of the engine, wherein
the hydrogen rich gas supply pipe is connected to an inlet pipe via a diversion valve so that air can be supplied from the hydrogen rich gas supply valve to the combustion chamber of the engine.

9. The engine system according to claim 2, further comprising;
a medium supply means for supplying the medium as one of the fuels to the combustion chamber of the engine, wherein
the volume of the air is controlled according to the ratio of the supply quantity of hydrogen rich gas to the supply quantity of fuel supplied to the engine.

10. The engine system according to claim 2, further comprising;
a medium supply quantity control means for controlling the supply quantity of the medium supplied to a hydrogen supply apparatus or
a heat supply quantity control means for controlling the supply quantity of heat supplied to a hydrogen supply apparatus based on the supply quantity or supply pressure detected by the detection means.

11. An engine system for driving an engine that uses hydrogen rich gas as one of the fuels comprising;
an inlet valve disposed in the combustion chamber of the engine,
an inlet pipe connected to the inlet valve, and
a hydrogen rich gas supply pipe which is connected to the inlet pipe to supply the hydrogen rich gas to the engine, wherein
a diversion valve is disposed at the connection between the inlet pipe and the hydrogen rich gas supply pipe.

12. The engine system according to claim 11, further comprising;
a diversion valve control means for controlling the diversion valve so that the hydrogen rich gas supply pipe is connected to the inlet valve at the beginning of the intake stroke of the engine, and the hydrogen rich gas supply pipe is disconnected from the inlet valve after a prescribed amount of hydrogen has been supplied to the engine, and then the inlet valve is connected to the inlet pipe.

13. The engine system according to claim 11, further comprising;
an inlet valve control means for controlling the open/close timing and the amount of open/close lift of the inlet valve.

14. The engine system according to claim 13, further comprising;
a detection means for detecting the supply quantity or supply pressure of hydrogen rich gas which is disposed in the hydrogen rich gas supply pipe, wherein
the open/close timing and the amount of open/close lift of the inlet valve are controlled based on the supply quantity or supply pressure detected by the detection means.

15. The engine system according to claim 11, further comprising;
a hydrogen supply apparatus for generating hydrogen gas from a medium which chemically repeats storage and release of hydrogen, wherein
hydrogen rich gas generated by the hydrogen supply apparatus is supplied to the combustion chamber of the engine.

16. The engine system according to claim 13, further comprising;
a medium supply quantity control means for controlling the supply quantity of the medium supplied to the hydrogen supply apparatus or
a heat supply quantity control means for controlling the supply quantity of heat supplied to the hydrogen supply apparatus based on the supply quantity or supply pressure detected by the detection means.
